(19) United States
(12) Patent Application Publication
(10) Pub. No.: US 2012/0067820 A1
(43) Pub. Date: Mar. 22, 2012

(54) METHOD AND APPARATUS FOR DYNAMIC, VARIABLE-PRESSURE, CUSTOMIZABLE, MEMBRANE-BASED WATER TREATMENT FOR USE IN IMPROVED HYDROCARBON RECOVERY OPERATIONS

(75) Inventors: Lisa Henthorne, Tampa, FL (US); Ben Movahed, Silver Spring, MD (US)

(73) Assignee: WATER STANDARD COMPANY LLC, Houston, TX (US)

(21) Appl. No.: 12/887,214

(22) Filed: Sep. 21, 2010

(51) Int. Cl. C02F 1/44; B01D 35/02

(52) U.S. Cl. 210/641; 210/650; 210/321.6; 210/170.05; 210/651; 210/321.64; 210/258; 210/321.66; 210/170.11

(57) ABSTRACT

A method for treating seawater that includes the step of intaking water into at least one treatment block, wherein the treatment block includes a membrane pressure vessel having at least one membrane element, wherein the treatment block is configured such that the intake water is fed through the at least one membrane element of the membrane pressure vessel, is disclosed. The disclosed method further includes the steps of feeding the intake water through the membrane pressure vessel at a custom pressure based on the at least one membrane element of the membrane pressure vessel, and separating the intake water into at least an aqueous permeate stream and a concentrate reject stream; and outputting the aqueous permeate stream and the concentrate reject stream.

### BACKGROUND OF INVENTION

1. Field of the Invention

Embodiments disclosed herein relate generally to a method and apparatus for dynamic, variable-pressure, customizable, membrane-based water treatment for use in improved hydrocarbon recovery operations.

2. Background Art

Hydrocarbons accumulated within a subterranean hydrocarbon-bearing formation are recovered or produced therefrom through production wells drilled into the subterranean formation. When production of hydrocarbons slows, improved recovery techniques may be used to force the hydrocarbons out of the formation. One of the simplest methods of forcing the hydrocarbons out of the formation is by direct injection of fluid into the formation. This enhances production by displacing or sweeping hydrocarbons through the formation so that they may be produced from production well(s).

As shown in FIG. 1, a prior art system for recovering hydrocarbons from a formation consists of an offshore rig 12 connected to a well 10, which is completed in a subterranean hydrocarbon-bearing formation 14. Generally, fluid is injected directly into the subterranean hydrocarbon-bearing formation 14 (indicated by the down arrow) and forces the hydrocarbons through the formation and out of the well 10 (indicated by the up arrow) via a production well, which may be the same or a different well. One type of such recovery operation uses water (e.g., seawater, produced water) as the injection fluid, which is referred to as a waterflood. Water is injected, under pressure, into the formation via injection wells, driving the hydrocarbons through the formation toward production wells.

Injection water used in waterflooding for offshore wells is typically seawater and/or produced water because of the low-cost availability of seawater and/or produced water at offshore locations. Another motivation for using produced water as an injection water offshore is the difficulty in some locations in disposing the produced water offshore. In any case, seawater and produced water are generally characterized as saline, having a high ionic content relative to fresh water. For example, the fluids are rich in sodium, chloride, sulfate, magnesium, potassium, and calcium ions, to name a few. Some ions present in injection water can benefit hydrocarbon production. For example, certain combinations of cations and anions, including K⁺, Na⁺, Cl⁻, Br⁻, and OW, can stabilize clay to varying degrees in a formation susceptible to clay damage from swelling or particle migration.

However, it has also been found that certain ions, including calcium and/or sulfate, present in the injection water can have harmful effects on the injection wells and production wells and can ultimately diminish the amount or quality of the hydrocarbon product produced from the production wells. Specifically, sulfate ions can form salts in situ when contacted with metal cations such as barium and/or strontium, which may be naturally occurring in the reservoir. Barium and strontium sulfate salts are relatively insoluble and readily precipitate out of solution under ambient reservoir conditions. Solubility of the salts further decreases as the injection water is produced to the surface with the hydrocarbons because of temperature decreases in the production well. The resulting precipitates accumulate as barium sulfate scale in the outlying reservoir, at the wellbore of the hydrocarbon production wells, and downstream thereof (e.g., in flow lines, gas/liquid separators, transportation pipelines, etc). The scale reduces the permeability of the reservoir and reduces the diameter of perforations in wellbores, thereby diminishing hydrocarbon recovery from the hydrocarbon production wells.

It has also been reported that a significant concentration of sulfate ions in injection water promotes reservoir souring. Reservoir souring is an undesirable phenomenon whereby reservoirs are initially sweet upon discovery, but turn sour during the course of waterflooding and attendant hydrocarbon production from the reservoir. Souring contaminates the reservoir with hydrogen sulfide gas or other sulfur-containing species and is evidenced by the production of quantities of hydrogen sulfide gas along with the desired hydrocarbon fluids from the reservoir via the hydrocarbon production wells. The hydrogen sulfide gas causes a number of undesired consequences at the hydrocarbon production wells and downstream of the wells, including excessive degradation and corrosion of the hydrocarbon production well metallurgy and associated production equipment, diminished economic value of the produced hydrocarbon fluids, an environmental hazard to the surroundings, and a health hazard to field personnel.

The hydrogen sulfide is believed to be produced by an anaerobic sulfate reducing bacteria. The sulfate reducing bacteria is often indigenous to the reservoir and is also commonly present in the injection water. Sulfate ions and organic carbon are the primary feed reactants used by the sulfate reducing bacteria to produce hydrogen sulfide in situ. The injection water is usually a plentiful source of sulfate ions, while formation water is a plentiful source of organic carbon in the form of naturally-occurring low molecular weight fatty acids. The sulfate reducing bacteria effects reservoir souring by metabolizing the low molecular weight fatty acids in the presence of the sulfate ions, thereby reducing the sulfate to hydrogen sulfide. Stated alternatively, reservoir souring is a reaction carried out by the sulfate reducing bacteria which converts sulfate and organic carbon to hydrogen sulfide and byproducts.

A number of strategies have been employed in the prior art for remediating reservoir souring with limited effectiveness. These prior art strategies have primarily been single pronged attacks against either the sulfate reducing bacteria itself or against a specific food nutrient of the sulfate reducing bacteria. For example, many prior art strategies have focused on killing the sulfate reducing bacteria in the injection water or within the reservoir. Conventional methods for killing the sulfate reducing bacteria or limiting their growth may include ultraviolet light, biocides, and chemicals such as acrolein and nitrates. Other prior art strategies for remediating reservoir souring have focused on limiting the availability of sulfates or organic carbon to the sulfate reducing bacteria.

More recently, strategies for remediating reservoir souring have included the use of membranes to reduce the concentration of sulfate ions in injection water. For example, U.S. Pat. No. 4,723,603 shows that specific membranes can effectively reduce the concentration of sulfate ions in injection water, thereby inhibiting sulfate scale formation. As taught by the prior art, nanofiltration (NF) membranes are often preferred to reverse osmosis (RO) membranes because nanofiltration membranes generally permit a higher passage of sodium chloride compared to reverse osmosis membranes. Consequently, nanofiltration membranes are advantageously operable at substantially lower pressures and operating costs than reverse osmosis membranes. Furthermore, nanofiltration membranes also maintain the ionic strength of the resulting injection water at a relatively high level, which desirably reduces the risk of clay instability and correspondingly reduces the risk of water permeability loss through the porous substrata of the subterranean formation.

However, in addition to the problems associated with sulfate ions being present in the injection water, it has also been found that the salinity of an injection water can have a major impact on the recovery of hydrocarbons during waterfloods, with increased recovery resulting from the use of injection water of lower salinity than natural seawater but sufficient ionic strength to prevent clay instability. Depending on the type of formation, injection fluids having higher salinity may cause the reservoir wettability to become more oilwet. This is because the multivalent cations in the brine, such as Ca⁺² and Mg⁺², are believed to act like bridges between the negatively charged oil and the negatively charged clay minerals that typically line the porewalls of the formation. The oil reacts with the clay particles to form organo-metallic complexes, which results in the clay surface being extremely hydrophobic and oilwet. As the oilwetness of the reservoir rock increases, hydrocarbons will adsorb onto the surface of the rock and thereby flow less easily from the formation, relative to water, which results in less hydrocarbon product being produced.

Lowering the electrolyte content (i.e., lowering the ionic strength) by lowering the overall salinity and especially reducing the multivalent cations in a brine solution reduces the screening potential of the cations. This results in increased electrostatic repulsion between the clay particles and the oil. Once the repulsive forces exceed the binding forces via the multivalent cation bridges, the oil particles are desorbed from the clay surfaces and the clay surfaces become increasingly waterwet. If, however, the electrolyte content is reduced too much (i.e., the brine salinity is too low), the clay particles may be stripped from the porewalls (clay deflocculation), which will damage the formation. Thus, although it is desirable to have lower salinity injection water, it is important that the salinity levels not be too low.

Lower salinity water, however, is not often available at a well site. Consequently, lower salinity water is typically prepared, for example, by reducing the total ion concentration of higher salinity water using membrane separation technology (e.g., reverse osmosis). In known seawater desalination plants operating according to the reverse osmosis process, the seawater to be desalinated is subjected to a separation process by means of a semi-permeable membrane. Such a membrane is understood to be a selective membrane, which is permeable to a high degree to the water molecules, but only to a very low extent to the salt ions dissolved therein.

Membrane separation techniques used in the preparation of low salinity injection water use reverse osmosis (RO) membrane elements. Membrane separation techniques used in the preparation of low sulfate injection water use nanofiltration (NF) membrane elements. The RO and NF processes use hydraulic pressure to produce lower salinity water from feed water through a semipermeable membrane. Depending on the membrane type, pressure and water conditions, an amount of salt also passes across the membrane, but the overall salinity of the product water is less than that of the feed water. Current RO technology can be used for desalinating both seawater and brackish water. The membranes used in the RO process are generally either made from polyamides or from cellulose sources.

The water to be treated is typically pretreated using media filtration, microfiltration, or ultrafiltration methods, which are known to separate solids/particulates from the water based on their size. The water is then fed to the reverse osmosis and/or nanofiltration vessel using a high-pressure pump. The required pressure from the high-pressure pump is a function of the osmotic pressure, the temperature, the flux (i.e., the rate at which the water passes through a unit area of the membrane), and the volume of the feed water to be produced with a specific membrane area. The product water (i.e., the permeate) is discharged from the membrane module by way of a permeate conduit. A concentrate conduit serves for discharging concentrated ionic water.

The operating costs for both systems (i.e., reverse osmosis and nanofiltration) are primarily determined by the energy to be applied. The greatest energy consumer is the drive of the high-pressure pump, which forces the seawater to be treated through the semi-permeable membranes of the membrane module. The driving force for permeation for membrane separation is the net pressure across the membrane (which is defined as the feed pressure minus the permeate or back pressure) less the difference between the osmotic pressure of the feed and the osmotic pressure of the permeate. Because nanofiltration membranes allow high salt passage for monovalent ions, the osmotic pressure of the permeate is significant, which allows the membranes to partially desalinate the seawater while operating at pressure below the actual osmotic pressure of the feed.

Energy saving measures are usually employed, especially in connection with reverse osmosis plants operating on the large scale, in order to keep the costs of desalination as low as possible. However, the energy required to drive the high-pressure pump varies based on what type of membrane technology is being used because different membranes require different pressures and, therefore, different pumps. For example, reverse osmosis is a high pressure process that requires a high-pressure pump that will provide, for example, approximately 800-1200 psi (˜55-82 bar) of pressure to the seawater, whereas nanofiltration is a low to moderately high pressure process that requires a pump that will provide, for example, approximately 50-450 psi (˜3-31 bar) of pressure to the seawater.

A number of efforts have been made in the prior art to minimize the cost associated with operating a membrane system. Most often, a treatment plant will comprise several membranes connected in series and/or parallel, wherein all of the membranes are of a similar type. For example, a prior art desalination plant will typically include multiple blocks (or trains) of reverse osmosis membranes. In such systems, pretreated seawater is pumped through the membrane using pressure from a high-pressure pump. These systems, however, are typically limited to membranes of a similar kind, because then only one model of pump is required, which keeps the cost associated with driving the pump to a minimum.

### SUMMARY OF INVENTION

In one aspect, embodiments disclosed herein relate to a method for treating seawater that includes the step of intaking water into at least one treatment block, wherein the treatment block includes a membrane pressure vessel having at least one membrane element, wherein the treatment block is configured such that the intake water is fed through the at least one membrane element of the membrane pressure vessel. The method further includes the steps of feeding the intake water through the membrane pressure vessel at a custom pressure based on the at least one membrane element of the membrane pressure vessel, and separating the intake water into at least an aqueous permeate stream and a concentrate reject stream; and outputting the aqueous permeate stream and the concentrate reject stream.

In another aspect, embodiments disclosed herein relate to a membrane-based water treatment system that includes a water intake system that intakes water, at least one treatment block having a variable speed high-pressure pump and a membrane pressure vessel comprising at least one membrane element, and an output system that respectively outputs the aqueous permeate stream and the concentrate reject stream, wherein the variable speed high-pressure pump feeds the intake water through the membrane pressure vessel at a custom pressure based on the membrane elements comprised in the membrane pressure vessel, and wherein the membrane pressure vessel separates the intake water into at least an aqueous permeate stream and a concentrate reject stream.

Other aspects and advantages of the invention will be apparent from the following description and the appended claims.

### BRIEF DESCRIPTION OF DRAWINGS

FIG. 1 shows a prior art offshore production well.

FIG. 2 shows a seawater treatment process according to one or more embodiments of the present invention.

FIG. 3A is a diagram of a seawater treatment unit on a vessel according to one or more embodiments of the present invention.

FIG. 3B is a diagram of a seawater treatment unit on an off-shore rig according to one or more embodiments of the present invention.

FIG. 3C is a diagram of a rig, a vessel, and a seawater treatment unit on the seafloor according to one or more embodiments of the present invention.

FIG. 4A shows another seawater treatment process according to one or more embodiments of the present invention.

FIG. 4B shows a treatment block according to one or more embodiments of the present invention.

FIG. 4C shows a spiral wound membrane element according to one or more embodiments of the present invention.

FIG. 4D shows a schematic for a hollow fine fiber membrane element according to one or more embodiments of the present invention.

FIG. 5 shows an improved oil recovery system according to one or more embodiments of the present invention.

FIG. 6A shows a configuration for a system or method according to one or more embodiments of the present invention.

FIG. 6B shows a configuration for a system or method according to one or more embodiments of the present invention.

FIG. 7 shows a configuration for a system or method according to one or more embodiments of the present invention.

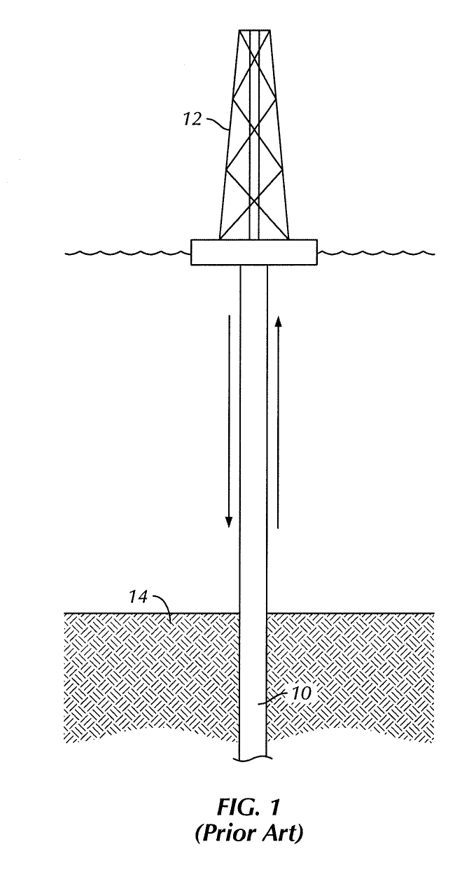

### DETAILED DESCRIPTION

One or more embodiments of the present invention will be described below with reference to the figures. In one aspect, embodiments disclosed herein relate to systems and methods for treating seawater using membrane technology to prepare an aqueous fluid having specific ions removed therefrom. In another aspect, embodiments disclosed herein relate to creating a customized pressure based on the type of membranes used in a water treatment process. In yet another aspect, embodiments disclosed herein relate to the treatment of seawater using a treatment system to produce an aqueous fluid which has specifically tailored properties and which is capable of being used as an injection fluid to be used in improved oil recovery operations. In yet another aspect, embodiments disclosed herein relate to blending treated fluids which have specifically tailored properties. In yet another aspect, embodiments disclosed herein relate specifically to improved oil recovery operations in offshore wells.

Seawater Treatment

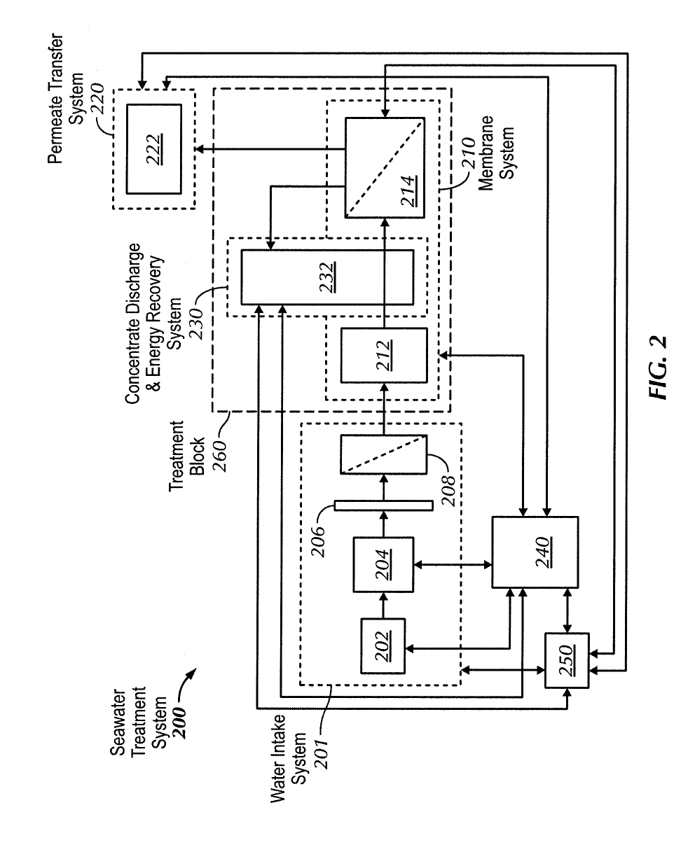

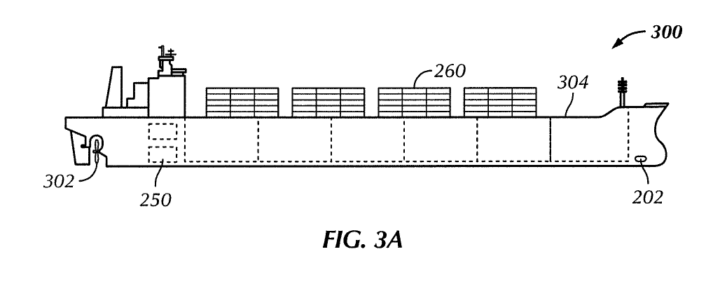

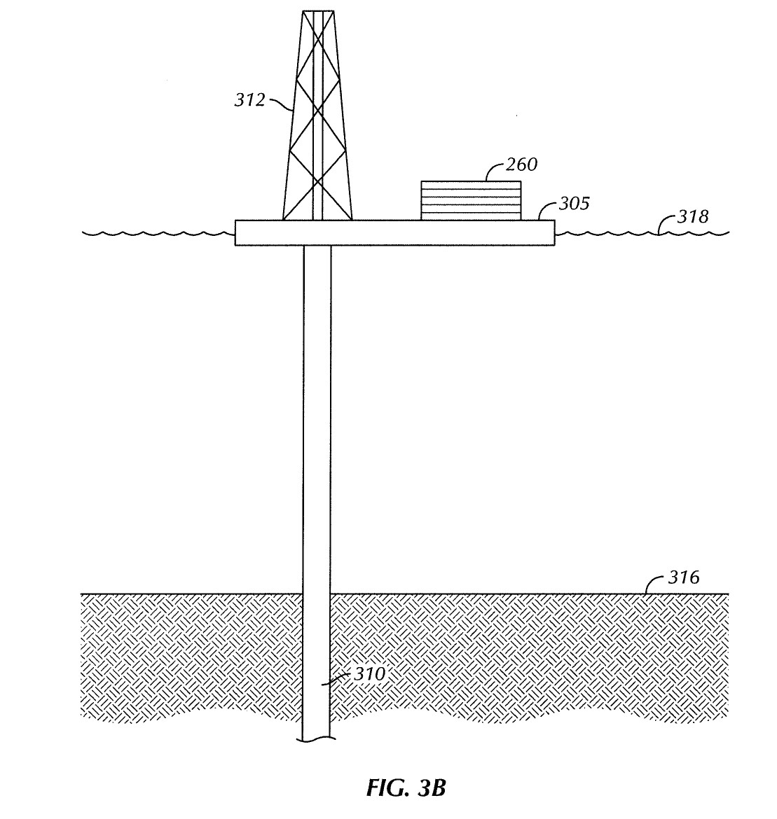

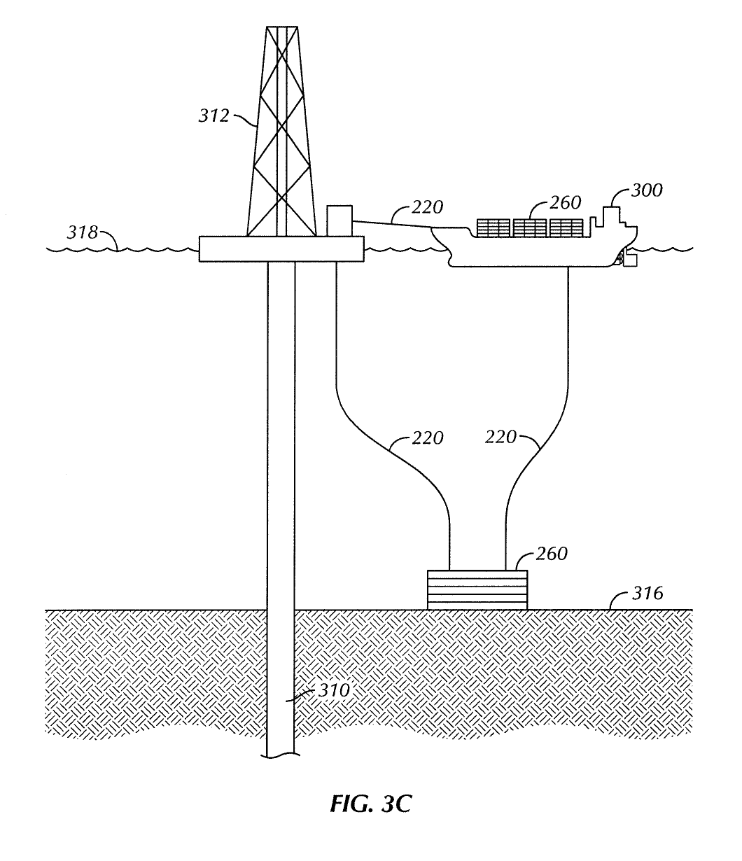

Referring to FIGS. 2 and 3A-C, a seawater treatment system according to one or more embodiments is shown. As shown in FIG. 2, the present invention provides a single-pump, single-pass seawater treatment system 200 that may include a water intake system 201, a membrane system 210, permeate transfer system 220, a concentrate discharge and energy recovery system 230, a control system 240, and a power source 250. Water intake system 201 may include water intake 202, water intake pump 204, pre-filter 206, and membrane/media-filter 208; membrane system 210 may include a variable speed high-pressure pump 212 and either a reverse osmosis and/or nanofiltration membrane 214; the concentrate discharge and energy recovery system 230 may include a turbobooster, turbocharger, or other energy recovery device 232 and a plurality of discharge ports; and permeate transfer system 220 may include a permeate transfer pump 222. As shown in FIGS. 3A-C, the seawater treatment system 200 may be provided on a vessel 300, on a rig 312, and/or on the seafloor 316.

Additionally, according to one or more embodiments, treatment block 260 may be used to describe the system that includes, for example, both membrane system 210 and concentrate discharge and energy recovery system 230.

The treatment block 260 is in communication with the water intake system 201 and the permeate transfer system 220. Both the control system 240 and the power source 250 are in communication with one another, as well as in communication with the water intake system 201, the permeate transfer system 220, and treatment block 260 (i.e., membrane system 210 and concentrate discharge and energy recovery system 230). As used herein, the terms “communicate” or “communication” mean to mechanically, electrically, or otherwise contact, couple, or connect by direct, indirect, or operational means.

Within the water intake system 201, water intake pump 204 pumps the intake water through pre-filter 206 to remove any large contaminants (e.g., sand, rocks, plants, debris, etc.) and then through a low pressure membrane or media filter 208 to remove large molecules (e.g., suspended solids, colloids, macromolecules, bacteria, oils, particulate matter, proteins, high molecular weight solutes, etc.). One of ordinary skill in the art will appreciate that depending on the specifications of the equipment and the type and density of particulate matter to be removed, various types of filters, including for example, sand or media filters, cartridge filters, ultra filters, and/or micro filters may be used.

Furthermore, the water intake system 201 may include one or more variable-depth extension members capable of extending into the body of water so as to intake water from a desired depth. Additionally, the extension member may include one or more intake screens designed to help prevent fouling of the intakes by marine life or other particles. One of ordinary skill in the art will appreciate that depending on the intended body of water from which water is being taken, other equipment may also be employed.

After passing through water intake system 201, the filtered seawater is provided to treatment block 260 wherein a variable speed high-pressure pump 212 pushes the filtered seawater through to membrane 214, whereby a concentrate is created on the high pressure side of the membrane 214 and a permeate stream is created on the low pressure side of the membrane 214.

The permeate stream may comprise water that has specific ions and/or molecules removed therefrom, for example, the permeate stream may have lower sulfate ion content and/or lower salinity compared to the filtered seawater produced from water intake system 201. The permeate stream may then be transferred, for example, from vessel 300 to rig 312, from seafloor 316 to rig 312, and/or from rig 312 to well 310, through permeate transfer system 220.

Permeate streams from various treatment blocks 260 may be blended. Each treatment block can use the same or a different type of RO or NF membrane requiring its respective pressure from the high-pressure pump 212. Blending the various permeate streams from each treatment block can then provide a very specific composition of mono- and divalent ions as a function of optimum reservoir performance.

In a different embodiment, a permeate stream from a treatment block 260 can be further treated using forward osmosis (FO) to further refine the ionic balance as a function of achieving optimum reservoir performance.

In another embodiment, instead of seawater as the source of water through intake system 201, brackish water could be the feed water, thereby allowing the flexibility to switch between brackish water and seawater treatment.

The permeate transfer system 220 may be capable of transferring the permeate produced to a permeate delivery means comprising a pipeline in communication with the permeate transfer system 220. The pipe line may transfer the permeate, for example, from vessel 300 to rig 312, from seafloor 316 to rig 312, and/or from rig 312 to well 310.

The concentrate created on the high pressure side of the membrane 214 comprises the ions and/or molecules removed by membrane 214. The concentrate is then disposed of, for example, through a plurality of concentrate discharge ports within the concentrate discharge and energy recovery system 230. However, before the concentrate is disposed of, a turbobooster (or other energy recovery device) 232 is used to capture the energy possessed by the concentrate and return such energy to the variable speed high-pressure pump 212. By doing so, the operating costs the system can be reduced, for example, by 40-50%, by recovering part of the hydraulic energy contained in the concentrate line (i.e., the reject water line).

More specifically, as the untreated water is pumped across the membrane, a pressure differential is created and concentrated salt water is discharged via the concentrate line. This results in the concentrate line retaining considerable hydraulic energy. A volumetric pump installed in the concentrate line then operates as a turbine to reduce the pressure in the concentrate line and recover the excess energy. The recovered energy is then used to drive the high-pressure pump, which reduces the amount of energy that must be expended for driving the high-pressure pump.

Furthermore, the concentrate may be diluted or otherwise treated prior to disposal. For example, in one or more embodiments, the concentrate discharge and energy recovery system 230 may be configured to increase the mixing of the concentrate discharged into the surrounding body of water. The plurality of discharge ports of the concentrate discharge and energy recovery system 230 may be physically located above or below the water line 318 of the vessel 300 and/or the rig 312. Also, the discharge ports may be disposed on a variable-depth extension member that can be positioned so as to promote dispersion of the concentrate into the body of water.

In one or more embodiments, the effluent from membrane 214 (either the permeate stream or the concentrate) may take one or more subsequent passes through membrane 214.

According to one or more embodiments of the present invention, a separate power source may provide power to each of the water intake system 201, permeate transfer system 220, treatment block 260 (i.e., membrane system 210 concentrate discharge and energy recovery system 230), and propulsion device 302. For example, each of the water intake pump 204, variable speed high-pressure pump 212, and permeate transfer pump 222 may be in communication with a separate power source.

According to one or more embodiments, the seawater treatment system 200 may be land-based or provided on a vessel. Where the seawater treatment system 200 is provided on a vessel 300, vessel 300 may further comprise a propulsion device 302 in communication with the power source 250. The vessel 300 may be a self-propelled ship, a moored, towed, pushed or integrated barge, or a flotilla or fleet of such vessels. The vessel 300 may be manned or unmanned. The vessel 300 may be either a single-hull or double-hull vessel.

Alternatively, in one or more embodiments, one power source may provide power to a combination of two or more of the water intake system 201, membrane system 210, permeate transfer system 220, concentrate discharge and energy recovery system 230, and/or propulsion device 302 where the seawater treatment system 200 is provided on a vessel 300. For example, electric power for the variable speed high-pressure pump 212 may be provided by a generator driven by the power source for the vessel's propulsion device, such as a vessel's main engine. In such an embodiment, a step-up gear power take off or transmission would be installed between the main engine and the generator in order to obtain the required synchronous speed.

Further, an additional coupling between the propulsion device and the main engine allows the main engine to drive the generator while the vessel is not under way. Moreover, an independent power source (not shown), such as a diesel, steam, or gas turbine, renewable energy generator, or combinations thereof, may power the treatment block 260, the propulsion device 302, or both.

In other embodiments, the power source for seawater treatment system 200 may be dedicated solely to the seawater treatment system 200.

In yet other embodiments, the plurality of concentrate discharge ports of the concentrate discharge and energy recovery system 230 may act as an auxiliary propulsion device for the vessel 300 or act as the sole propulsion device for the vessel 300. Some or all of the concentrate may be passed to propulsion thrusters to provide idling or emergency propulsion.

In other embodiments, the power source 250 may comprise electricity producing windmills and/or water propellers that harness the flow of the air and/or water to generate power for the seawater treatment system 200 and/or the operation of the vessel 300 and/or rig 312.

For embodiments where the seawater treatment system 200 is on a vessel 300, the water intake system 201 may be capable of taking in seawater from the water surrounding the vessel 300 and providing it to the treatment block 260. In such embodiments, the water intake 202 of the water intake system 201 may include one or more apertures in the hull of the vessel 300 below the water line 318. An example of a water intake 202 is a sea chest (not shown). Water is taken into the vessel 300 through the one or more apertures (i.e., water intake 202), passed through the water intake pump 204, pre-filter 206, ultra filter 208, and supplied to the variable speed high-pressure pump 212.

For embodiments where the seawater treatment system 200 is on an offshore rig 312, the water intake system 201 may be capable of taking in seawater from the water surrounding the rig 312 and providing the seawater to the treatment block 260. In such embodiments, the water intake 202 of the water intake system 201 may include an intake riser(s), screen(s), and external or submerged pump(s).

For embodiments where the seawater treatment system 200 is on the seafloor 316, the water intake system 201 may be capable of taking in seawater from the water surrounding the seawater treatment system 200 and providing it to the membrane system 210. In such embodiments, the water intake 202 of the water intake system 201 may include an intake well or riser, screen(s) and pump(s).

The membrane system 210 may comprise a variable speed high-pressure pump 212 and a membrane 214. In one or more embodiments, membrane 214 is an ion selective membrane, which may selectively prevent or at least reduce hardening or scale-forming ions (e.g., divalent ions including sulfate, calcium, and magnesium ions) from passing across it, while allowing water and other specific ions (e.g., monovalent ions including sodium, chloride, bicarbonate, and potassium ions) to pass across it. The selectivity of the membrane may be a function of the particular properties of the membrane, including pore size and charge characteristics of the polymeric structure comprising the membrane. For example, a polyamide membrane, a cellulose acetate membrane, a nano-embedded membrane, and/or other membrane innovation may be used to selectively prevent or at least reduce sulfate, calcium, and magnesium ions from passing across it. In a particular embodiment, membrane 214 may reduce up to about 99% of the sulfate ions.

In one or more embodiments, membrane 214 is a desalting membrane, which may lower the total salinity or ionic strength of the filtered seawater by preventing or at least reducing ions (e.g., sodium, chloride, calcium, potassium, sulfate, bicarbonate, and magnesium ions) from passing across it.

In one or more embodiments, membrane 214 is a nanofiltration membrane. Examples of commercially available nanofiltration membranes suitable for use in the treatment process of the present disclosure may include, for example, FILMTEC™ SR90 Series, NF 200 Series, which is available from The Dow Chemical Company (Minneapolis, Minn.), or membranes with similar rejection properties from other membrane manufacturers.

In one or more embodiments, membrane 214 is a reverse osmosis membrane. Examples of commercially available reverse osmosis membranes suitable for use in the treatment process of the present disclosure may include, for example, FILMTEC™ SW 30 Series, which is available from The Dow Chemical Company (Minneapolis, Minn.), or other membranes with similar rejection properties from other membrane manufacturers.

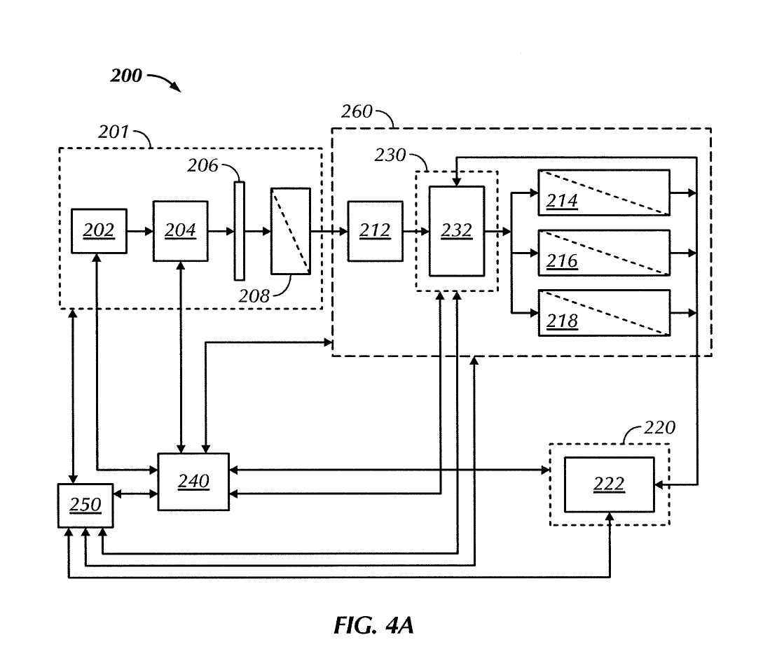

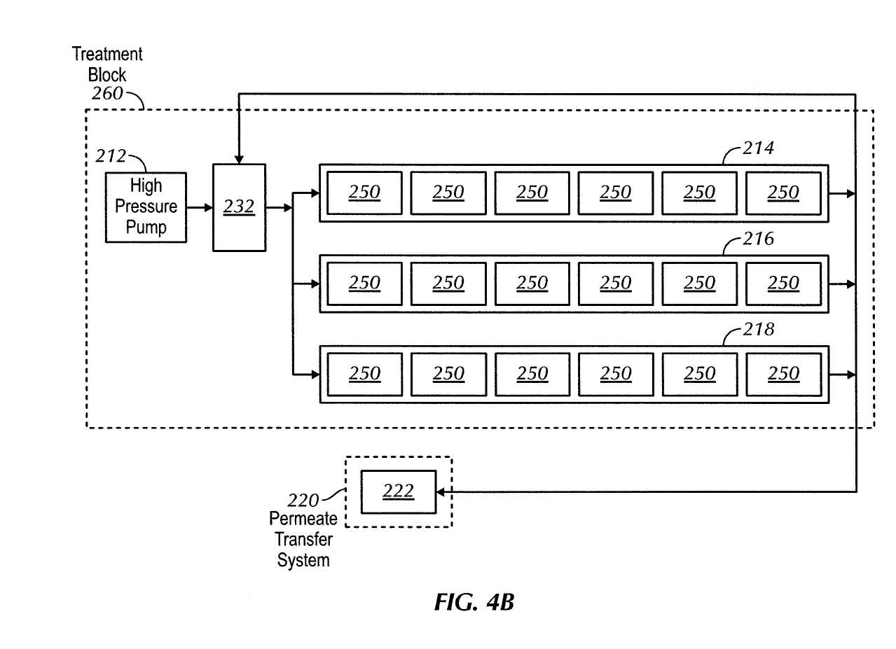

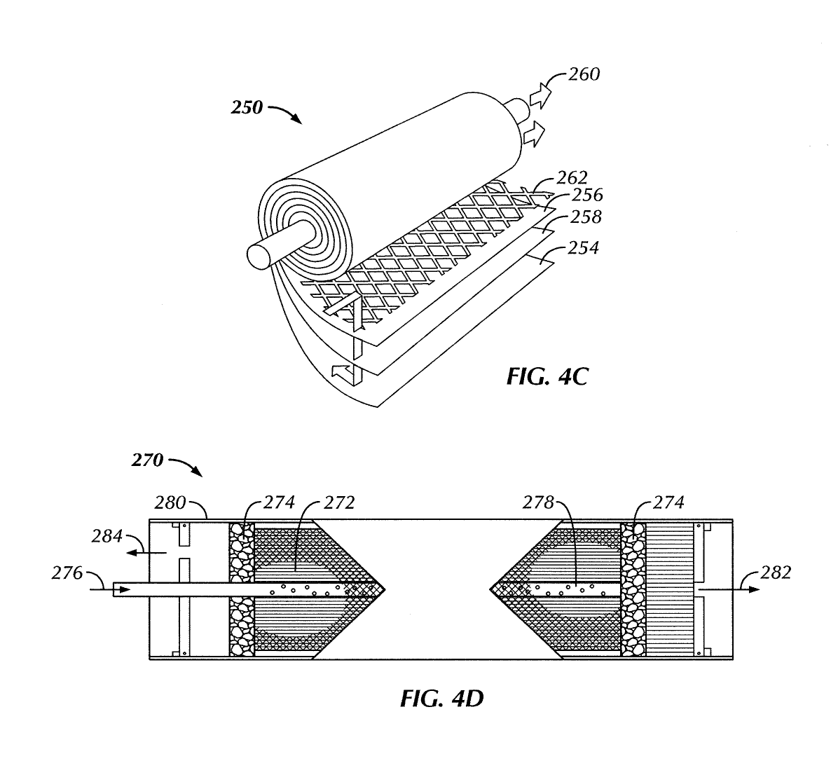

As shown in FIGS. 4A-B, the seawater treatment system 200 may include a membrane system 210 that includes a plurality of membrane pressure vessels (shown as 214, 216, and 218), which may be arranged in parallel. Although three membrane pressure vessels are shown, other embodiments may include more or less than three membranes. According to one or more embodiments, each membrane pressure vessel may include a plurality of membrane elements 250 installed therein. Although six elements 250 are shown in each membrane pressure vessel, other embodiments may include more or less than six elements 250.

As shown in FIGS. 4B-C, according to one or more embodiments, each element 250 may comprise, for example, reverse osmosis membrane elements, nanofiltration membrane elements, or other membrane elements known in the art. Membrane elements 250 may comprise one of several configurations known in the art, for example, spiral wound (SW) and/or hollow fine fiber (HFF).

As shown in FIG. 4C, according to one or more embodiments, elements 250 may comprise spiral wound elements 250. Spiral wound elements 250 may be constructed from flat sheet membranes 254 and 256 and may include a backing material 258 to provide mechanical strength. The membrane material may be cellulosic (i.e., cellulose acetate membrane) or non-cellulosic (i.e., composite membrane). For cellulose acetate membranes, the two layers may be different forms of the same polymer, referred to as “asymmetric.” For composite membranes, the two layers may be completely different polymers, with the porous substrate often being polysulfone.

In the spiral wound design, the membrane is formed in an envelope that is sealed on three sides. A supporting grid, called the product water carrier, is on the inside. The envelope is wrapped around a central collecting tube 260, with the open side sealed to the tube. Several envelopes, or leaves, are attached with an open work spacer material 262 between the leaves. This is the feed/concentrate, or feed-side spacer. The leaves are wound around the product water tube 260, forming spirals if viewed in cross section. Each end of the unit may be finished with a plastic molding, called an “anti-telescoping device,” and the entire assembly may be encased in a thin fiberglass shell (not shown). Feed water may flow through the spiral over the membrane surfaces, roughly parallel to the product water tube 260. Product water flows in a spiral path within the envelope to the central product water tube 260. A chevron ring (not shown) around the outside of the fiberglass shell may force the feed water to flow through the element 250.

As shown in FIG. 4D, according to one or more embodiments, elements 250 may comprise hollow fine fiber elements 270. The design of the hollow fine fiber elements 270 may include a plurality of hollow fiber membranes 272 being placed in a membrane pressure vessel 280. The hollow fine fiber may be a polyaramid or a blend of cellulose acetates. The membranes 272 may have an outside diameter of about 100 to about 300 microns and in inside diameter between 50 and about 150 microns. The fibers may be looped in a U-shape, so both ends are imbedded in a plastic tubesheet 274. The pressurized seawater may be introduced into the vessel (indicated by arrow 276) along the outside of the hollow fibers. Under pressure, desalted water passes through the walls of the hollow fiber membranes 272 and flows down the inside of the fiber membranes 272 to a permeate collection tube 278 for collection (as indicated by arrow 282), while the separated concentrate is removed from the membrane pressure vessel 280 (as indicated by arrow 284).

According to one or more embodiments, all of the membrane pressure vessels in membrane system 210 may comprise elements 250 having only reverse osmosis membrane elements installed therein. In another embodiment, all of the membrane pressure vessels in membrane system 210 may comprise elements 250 having only nanofiltration membrane elements installed therein. In other embodiments, one or more membrane pressure vessel (e.g., membrane pressure vessel 214) may comprise elements 250 having only nanofiltration membrane elements installed therein while the remaining membrane pressure vessels (e.g., membrane pressure vessels 216 and 218) comprise elements 250 having only reverse osmosis membrane elements installed therein. In yet other embodiments, one or more membrane pressure vessel (e.g., membrane pressure vessel 214) may comprise elements 250 having only reverse osmosis membrane elements installed therein while the remaining membrane pressure vessels (e.g., membrane pressure vessels 216 and 218) comprise elements 250 having only nanofiltration membrane elements installed therein. While specific examples of combinations of membrane pressure vessels and membrane element types are listed here, these examples are not intended to be exhaustive and other combinations may be used. Those skilled in the art will appreciate other appropriate examples and combinations, which are intended to be encompassed by one or more embodiments.

As shown in FIGS. 3A-C, one or more treatment blocks 260 may be installed on the deck 304 of a vessel 300, on the platform 305 of a rig 312, and/or on the seafloor 316, depending on the location of the seawater treatment system 200. Additionally, the one or more treatment blocks may also be installed in other parts of the vessel 300 and/or the rig 312, or even on multiple levels of the vessel 300 and/or the rig 312. For example, each treatment block may be installed in a separate container. Several containers can be placed on top of each other to optimize the use of the deck 304 and/or platform 305 to decrease the time and expense associated with construction of the seawater treatment system on the vessel 300 and/or rig 312. The one or more treatment blocks may be installed in series or in parallel.

Within the water intake system 201, water intake pump 204 pumps the intake water through pre-filter 206 to remove any large contaminants (e.g., sand, rocks, plants, debris, etc.) and then through filter 208 to remove large molecules (e.g., suspended solids, colloids, macromolecules, bacteria, oils, particulate matter, proteins, high molecular weight solutes, etc.). After passing through water intake system 201, the filtered seawater is provided to treatment block 260 by variable speed high-pressure pump 212. Although only one treatment block 260 is shown, according to one or more embodiments, there may be more than one treatment block arranged in series and/or in parallel.

According to one or more embodiments, within treatment block 260, there may be one or more membrane pressure vessels (e.g., 214, 216, and 218). In one embodiment, the pressurized seawater may be pushed through the first membrane pressure vessel (e.g., 214) having one or more elements 250 with membrane elements installed therein, thereby creating a first permeate stream and a first concentrate stream. The first permeate stream may comprise water that has specific ions removed therefrom, for example, the first permeate stream may have lower sulfate ion content and/or lower salinity compared to the filtered seawater produced from water intake system 201. The first concentrate stream may comprise the ions and/or molecules removed by the membrane elements in the first membrane pressure vessel (e.g., 214). The first concentrate stream may then be disposed of, for example, through a plurality of concentrate discharge ports within the concentrate discharge and energy recovery system 230. However, before the first concentrate is disposed of, turbobooster (or other energy recovery device) 232 may be used to capture the energy possessed by the first concentrate stream and return such energy to the variable speed high-pressure pump 212.

According to one or more embodiments, this process may continue for as many membrane pressure vessels as there are in the treatment block 260. Additionally, this process may continue for as many treatment blocks 260 as there are in the treatment system 200, until a final permeate stream is produced from a final membrane pressure vessel. The final permeate stream may then be transferred, for example, from vessel 300 to rig 312, from seafloor 316 to rig 312, and/or from rig 312 to well 310, through the permeate transfer system 220.

In one or more embodiments, the membrane elements installed within the membrane pressure vessels (e.g., 214, 216, and 218) are all ion selective membrane elements that lower the salinity or ionic strength of the seawater by selectively preventing or at least reducing certain ions (e.g., sodium, calcium, potassium, and magnesium ions) from passing through the membrane elements, while allowing water and other specific ions (e.g., sulfate, calcium, magnesium, and bicarbonate ions) to be produced for use and/or further treatment. In other embodiments, the membranes elements are all ion selective membranes that selectively prevent or at least reduce hardening or scale-forming ions (e.g., sulfate, calcium, magnesium, and bicarbonate ions) from passing through the membrane elements, while allowing water and other specific ions (e.g., sodium and potassium ions) to be produced for use and/or further treatment.

In one or more embodiments, treatment block 260 may comprise different combinations of membrane pressure vessels, i.e., the membrane elements installed within the membrane pressure vessels (e.g., 214, 216, and 218) may comprise different membrane elements. For example, in one embodiment, two of the membrane pressure vessels may comprise only nanofiltration membrane elements while the third membrane pressure vessel comprises only reverse osmosis membrane elements. In another embodiment, two of the membrane pressure vessels may comprise only reverse osmosis membrane elements while the third membrane pressure vessel comprises only nanofiltration membrane elements. Additionally, one of ordinary skill in the art would recognize that there may be more or less than three membranes blocks in the treatment block. Furthermore, the particular design of membrane may vary in one or more embodiments. Rather, one of ordinary skill in the art in possession of the present disclosure will recognize that the membrane may be, for example, spirally wound, hollow fiber, tubular, plate and frame, or disc-type.

According to one or more embodiments, the variable speed high-pressure pump that operates to push the pretreated water through the treatment block 260 may comprise any pump suitable to generate the hydraulic pressure necessary to push the water through the one or more membrane pressure vessels. However, the pump discharge pressure must be controlled in order to maintain the designated permeate flow and, more importantly, to not exceed the maximum allowed feed pressure for the membrane elements being used. This is of particular importance because if the maximum allowed feed pressure is exceeded, the membrane element may blow out and thereby fail prematurely. Because the maximum allowed feed pressure for nanofiltration elements is typically much greater than the maximum allowed feed pressure for reverse osmosis element, conventional membrane systems having more than one type of membrane (e.g., nanofiltration and reverse osmosis) typically require more than one pump (i.e., a pump for each type of membrane). Conventional systems with nanofiltration membranes installed cannot change to reverse osmosis membranes due to this pressure differential.

However, according to one or more embodiments, the treatment block 260 may include a single variable-speed high-pressure pump 212 that provides the filtered seawater to more than one membrane pressure vessel. Because the membrane pressure vessels may vary in length and/or may include different types of membrane elements, and therefore require varying feed pressures, the high-pressure pump 212 must be able to provide an adjustable feed pressure based on the type of system being used. For example, pretreated seawater has an osmotic pressure of about 24, thus, for a nanofiltration membrane, pressurization of at least 20 bar must be exerted on the feed stream 210, while pressurization of at least 70 bar must be exerted for a reverse osmosis membrane. In one or more embodiments, the variable speed high-pressure pump may comprise, for example, a positive displacement pump.

In a preferred embodiment, the pump may be used to provide approximately 16,068 m³/d (or 670 m³/hr or 2950 gpm) at varying pressures. Specifically, for a seawater reverse osmosis (SWRO) treatment system with ERD, the lowest needed pressure is about 26.5 bar for a system that is 270 m (887 ft) in length. The highest needed pressure is about 30.2 bar for a system that is 308 m (1010 ft) in length. For an NF system with no ERD, the lower required pressure is about 27 bar for a system that is about 275 m (904 ft) in length. For an NF system with no ERD, the highest required pressure is 39 bar for a system that is about 398 m (1305 ft) in length. For a sulfate reducing nanofiltration (SRNF) system with no ERD, the lowest needed pressure is about 14 bar for a system that is 143 m (203 ft) in length. For a SRNF system with no ERD, the highest required pressure is about 19 bar for a system that is 194 m (276 ft) in length.

One or more embodiments of the present invention may also include variable frequency drives (VFD) on the high-pressure pump. The VFD are systems that control the rotational speed of an alternating current (AC) electric motor by controlling the frequency of the electrical power supplied to the motor. By employing VFD, the pressures created by the variable speed high-pressure pump can also be varied according to the specific needs of the system at any time, for example, as a function of operation, membrane type, water quality objectives, and/or seawater temperature and salinity.

However, the flexibility achieved from using variable frequency drives on the high-pressure pump is limited. Thus, according to one or more embodiments, it may be advantageous to couple the VFD system with an energy recovery system. For example, as shown in FIGS. 2 and 4A-B, according to one or more embodiments, energy may be recovered from the concentrate stream using a turbobooster (or other energy recovery device) 232. In seawater systems, typically about 55 to 60% of the pressurized feed water leaves the system with about 60 bar pressure in the concentrate stream. This energy can be recovered to decrease the specific energy demand of the system. In addition to a turbobooster, energy recovery methods may include pelton wheel, reverse turning turbine, and/or piston type work exchanger. The high pressure concentrate is fed into the energy recovery device (e.g., the turbobooster or other energy recovery device) where it produces a rotating power output. This may be used to assist the main electric motor in driving the high-pressure pump. Compared to traditional pump drives, the energy recovery system represents energy savings up from about 40% to about 50%.

According to one or more embodiments, the recovered energy may be used to drive the variable speed high-pressure pump 212 that pumps the filtered seawater to the treatment block 260. In other embodiments, energy recovery may not be necessary to achieve sufficient pressure for operation of certain membranes, in which case the turbobooster may be bypassed.

When combined with the VFD on the variable speed high-pressure pump, turbobooster energy recovery may allow for a high-pressure pump to be adjusted according to the specific type of membrane elements being used. This is advantageous because typical high-pressure pumps are not capable of operating across the full range of pressures required for both nanofiltration and reverse osmosis membrane elements. As discussed above, depending on the type of membrane element being used, the pretreated seawater may need to be pressurized to the appropriate pressure that is below the osmotic pressure of the solution prior to entry into a membrane. Pretreated seawater has an osmotic pressure of about 24, thus, for a nanofiltration membrane, pressurization of at least 20 bar (but no more than the maximum allowed feed pressure of ˜41 bar) must be exerted on the feed stream 210, while pressurization of at least 70 bar (but no more than the maximum allowed feed pressure of ˜82 bar) must be exerted for a reverse osmosis membrane.

Accordingly, one or more embodiments provide a seawater treatment system having the flexibility to switch between multiple membrane elements using a single high-pressure pump, whereby the seawater can be treated to produce any kind of water having specifically tailored properties without having to use multiple high-pressure pumps and/or having to pass through multiple treatment systems.

As discussed above, seawater has a high ionic content relative to fresh water. For example, seawater is typically rich in ions such as sodium, chloride, sulfate, magnesium, potassium, and calcium ions. Seawater typically has a total dissolved solids (TDS) content of at least about 30,000 mg/L. According to one or more embodiments, it is preferred that the permeate stream have a total dissolved solids content of less than about 4,000 mg/L, and more preferably from about 2,000 to about 4,000 mg/L.

Improved Oil Recovery

As noted above, improved oil recovery processes commonly inject water into a subterranean hydrocarbon-bearing reservoir via one or more injection wells to facilitate the recovery of hydrocarbons from the reservoir via one or more hydrocarbon production wells. The water can be injected into the reservoir as a waterflood in a secondary oil recovery process. Alternatively, the water can be injected into the reservoir in combination with other components as a miscible or immiscible displacement fluid in a tertiary oil recovery process. Water is also frequently injected into subterranean oil and/or gas reservoirs to maintain reservoir pressure, which facilitates the recovery of hydrocarbons and/or gas from the reservoir.

According to one or more embodiments, injection fluids may include aqueous solutions (e.g., seawater) that have been treated according to methods disclosed above. In a particular embodiment, the seawater may first undergo filtration in a water intake system whereby the seawater is pumped through a first filter to remove any large contaminants (e.g., sand, rocks, plants, debris, etc.) and then through a second filter to remove large molecules (e.g., suspended solids, colloids, macromolecules, bacteria, oils, particulate matter, proteins, high molecular weight solutes, etc.). One of ordinary skill in the art will appreciate that depending on the specifications of the equipment and the type and density of particulate matter to be removed, various types of filters, including for example, sand or media filters, cartridge filters, ultra filters, and/or micro filters may be used.

After passing through the water intake system, the filtered seawater may be provided to a seawater treatment system such as the one depicted in the figures of the present disclosure. Specifically, as shown in FIGS. 4A-B, the filtered seawater may be provided to a treatment block 260 by a variable speed high-pressure pump 212, which pushes the filtered seawater through to one or more membrane pressure vessels (e.g., 214, 216, and 218), thereby creating a permeate stream and a concentrate stream.

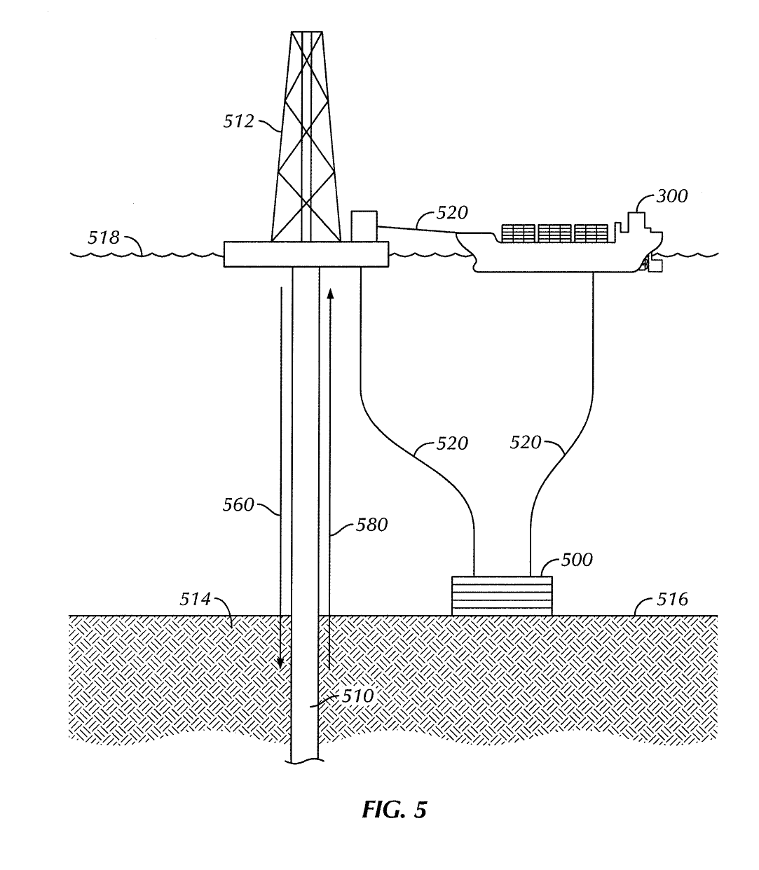

The permeate stream may comprise water that has specific ions and/or molecules removed therefrom, for example, the permeate stream may have lower sulfate ion content and/or lower salinity compared to the filtered seawater produced from the water intake system. As shown in FIG. 5, the permeate stream may then be transferred, for example, from vessel 300 to rig 512, from seafloor 516 to rig 512, and/or from rig 512 to well 510, through permeate transfer system 520 and used as an injection fluid for improved recovery of hydrocarbons from a subterranean hydrocarbon-bearing formation 514.

The concentrate stream may comprise the ions and/or molecules removed by the membrane elements within the one or more membrane pressure vessels. The concentrate stream may then be disposed of, for example, through a plurality of concentrate discharge ports within the concentrate discharge and energy recovery system. However, before the concentrate is disposed of, a turbobooster may be used to capture the energy possessed by the concentrate stream and return such energy to variable speed high-pressure pump 212. Also, the concentrate may be diluted or otherwise treated prior to disposal.

In one or more embodiments, the effluent from the one or more membrane pressure vessels (either the permeate stream and/or the concentrate stream) may take one or more subsequent passes through treatment block 260. Additionally, in some embodiments, more than one treatment block may be used in the seawater treatment system.

In one or more embodiments, a method for recovering hydrocarbons from a subterranean hydrocarbon-bearing formation 514 may include injecting the permeate stream into a hydrocarbon-bearing formation 514 via an injection well 560, displacing hydrocarbons with the permeate towards an associated hydrocarbon production well 580, and recovering the hydrocarbons from the formation 514 via the hydrocarbon production well 580.

Preferably, the methods of one or more embodiments may result in an increase in hydrocarbon recovery from a hydrocarbon bearing formation, for example in the range of about 2% to about 40%, when compared with a waterflood treatment using untreated high salinity injection water.

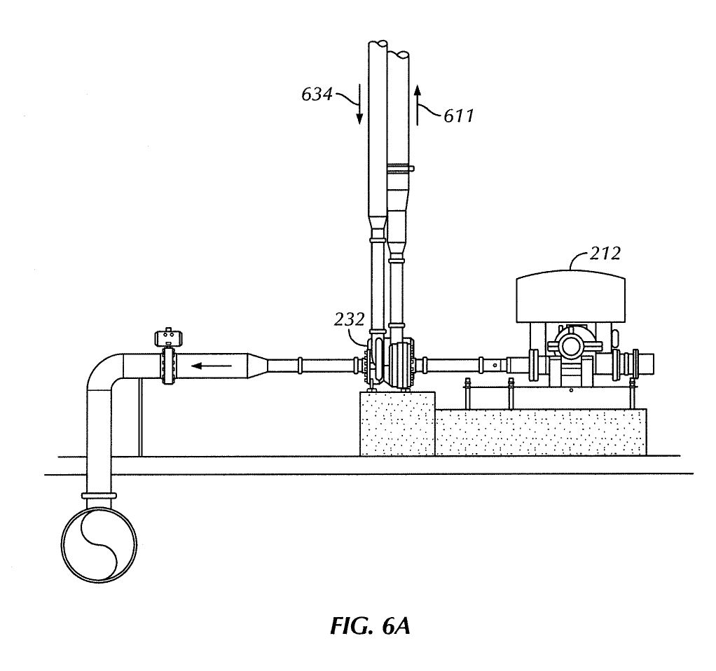

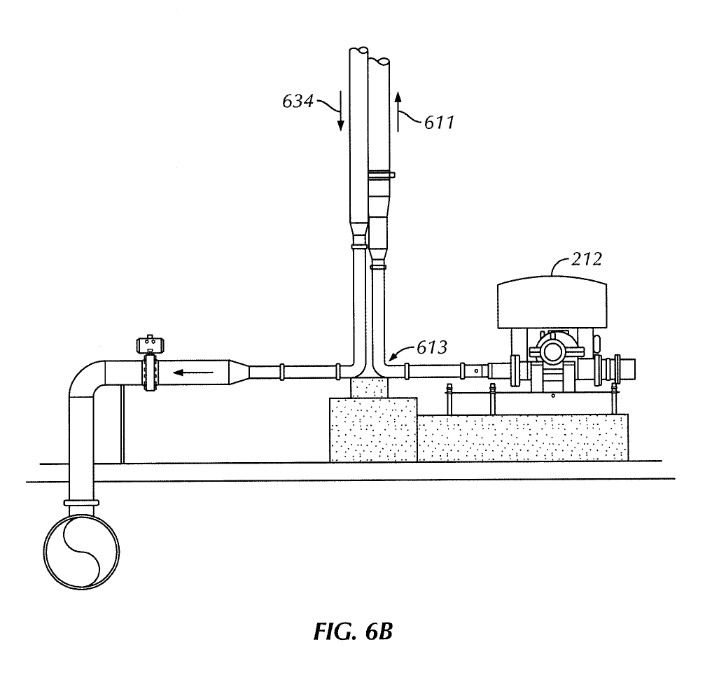

As shown in FIGS. 6A-B, the systems and methods of one or more embodiments of the present invention may be included in various configurations. Specifically, as shown in FIGS. 6A-B, a system and/or method of the present invention may be configured so that the variable speed high-pressure pump 212 pushes the filtered seawater 611 through one or more treatment blocks 212, thereby creating a concentrate stream 634 and a permeate stream (not shown). The concentrate stream 634 may then be disposed of, for example, through a plurality of concentrate discharge ports within the concentrate discharge and energy recovery system. However, before the concentrate stream 634 is disposed of, a turbobooster (or other energy recovery device) 232 may be used to capture the energy possessed by the concentrate stream 634 and return such energy to variable speed high-pressure pump 212. Also, the concentrate stream 634 may be diluted or otherwise treated prior to disposal. Alternatively, as shown in FIG. 6B, a system and/or method of the present invention may be configured so that the concentrate stream 634 bypasses the concentrate discharge and energy recovery system, for example, via elbow piping 613.

Additionally, in other embodiments of the present invention, the systems and/or methods of the present invention may be capable of switching back and forth between systems shown in FIGS. 6A-B. For example, when energy recovery is desired, the turbobooster 232 may be used to capture the energy possessed by the concentrate stream 634; however, when energy recovery is not required, the turbobooster 232 may be bypassed (as shown in FIG. 6B).

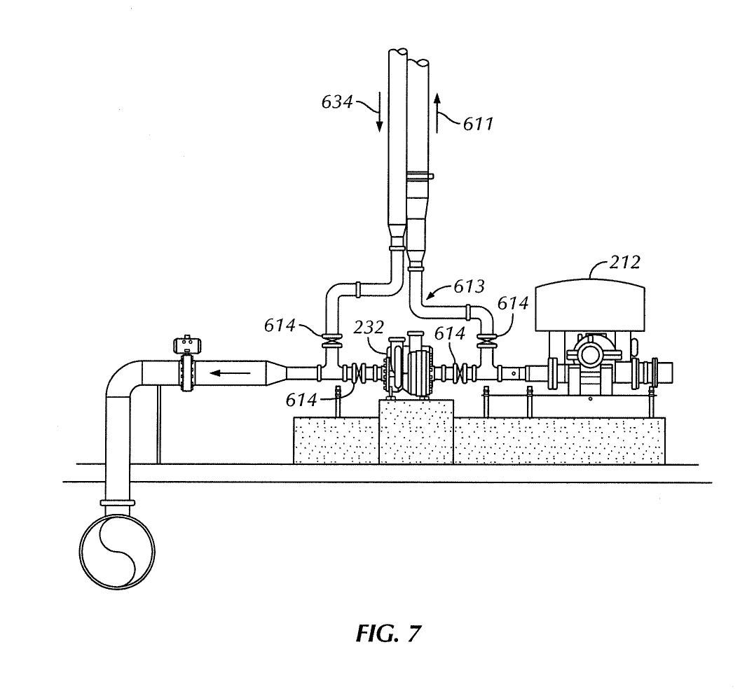

Furthermore, as shown in FIG. 7, a system and/or method according to one or more embodiments of the present invention may include both a turbobooster 232 and elbow piping 613, wherein the turbobooster 232 and the elbow piping 613 are connected via valves 614. In one embodiment, the valves 614 may be left open so as to allow the concentrate stream 634 to be piped directly in to the turbobooster 232. In another embodiment, some valves 614 may be closed so as to bypass the turbobooster 232. Also, the concentrate stream 634 may be diluted or otherwise treated prior to disposal.

### EXAMPLES

The following examples are provided to further illustrate the application and use of the methods and systems disclosed herein for treating seawater. The following examples were used to design a pressure center (i.e., pump and energy recovery) for a high-pressure seawater reverse osmosis (SWRO) system, then being converted to a nanofiltration system with minimum modification.

### Example 1

A first set of 3 samples of pretreated open intake seawater were fed separately to three RO membranes. The temperature of the water was 18° C. The flux used was 14.5 LMH (8.56 GFD), which is typical for MF/UF pretreated open intake seawater. Recovery used was 40%, which is typical for SWRO. Table 1 shows the results for the first set of 3 samples:

TABLE 1
Results for the first set of 3 seawater samples

| | Dow | | Hydranautics | | Koch | |
|---|---|---|---|---|---|---|
| RO Membrane | SW3OULE-400i | | SWC6 | | 8040-HF-400 | |
| Feed Pressure | 49.43 | bar | 48.9 | bar | 52.2 | bar |
| Concentrate Pressure | 47.37 | bar | 47.3 | bar | 51.3 | bar |
| Permeate TDS | 218 | mg/L | 264 | mg/L | 258 | mg/L |
| Permeate SO₄ | 1.74 | mg/L | 5.3 | mg/L | 3.6 | mg/L |

### Example 2

A second set of 3 samples of pretreated open intake seawater were fed separately to the same three RO membranes as used in Example 1. The temperature of the water was 25° C. The flux and recovery used was the same as in Example 1 (i.e., the flux was 14.5 LMH and the recovery was 40%) Table 2 shows the results for the second set of 3 samples:

TABLE 2
Results for the second set of 3 seawater samples

| | Dow | | Hydranautics | | Koch | |
|---|---|---|---|---|---|---|
| RO Membrane | SW3OULE-400i | | SWC6 | | 8040-HF-400 | |
| Feed Pressure | 48.03 | bar | 47.6 | bar | 50.0 | bar |
| Concentrate Pressure | 46.5 | bar | 46.0 | bar | 49.1 | bar |
| Permeate TDS | 353 | mg/L | 341 | mg/L | 360 | mg/L |
| Permeate SO₄ | 2.85 | mg/L | 6.9 | mg/L | 5.1 | mg/L |

### Example 3

A third set of 3 samples of pretreated open intake seawater were fed separately to the same three RO membranes as used in Examples 1 and 2. The temperature of the water was 31° C. The flux and recovery used was the same as in Examples 1 and 2 (i.e., the flux was 14.5 LMH and the recovery was 40%). Table 3 shows the results for the third set of 3 samples:

TABLE 3
Results for the third set of 3 seawater samples

| | Dow | | Hydranautics | | Koch | |
|---|---|---|---|---|---|---|
| RO Membrane | SW3OULE-400i | | SWC6 | | 8040-HF-400 | |
| Feed Pressure | 47.32 | bar | 47.2 | bar | 48.8 | bar |
| Concentrate Pressure | 45.94 | bar | 45.6 | bar | 48.0 | bar |
| Permeate TDS | 522 | mg/L | 413 | mg/L | 479 | mg/L |
| Permeate SO₄ | 4.25 | mg/L | 8.3 | mg/L | 282 | mg/L |

The following examples were used to combine an RO system with an NF system.

First, as shown in Example 4, the limits of the NF system had to be determined. This is because typical standard NF elements can be operated at higher recovery and flux compared to SWRO, for example, the flux may be approximately 17.0 LMH (about 10 GFP or higher) and the recovery may be approximately 70-75% using proper scale inhibitors. The samples of seawater used for the following examples are the same as the samples used for Examples 1-3, i.e., the samples were pretreated open intake seawater. Additionally, the feed flow to each membrane skid was the same, i.e., 16070 m³/d, so that the pump and pretreatment were the same.

### Example 4

The limits of the NF system were tested in order to determine the maximum recovery, the maximum permeate, the maximum pressure, the maximum feed, the system flux, the first stage flux, and the second stage flux. Table 4 shows the results obtained from a NF two-stage system comprising a Dow NF 90-400 system with water having temperature of 18° C. From the results of Example 4, it was concluded that a two-stage system will result in warnings and stages that are not balanced.

TABLE 4
NF Projection Run Results from two-stage system

| | | | NF Projection Run Results | | | |
|---|---|---|---|---|---|---|
| | | | Two Stage | Two Stage | Two Stage | Two Stage |
| Dow Limits | | | 2:1 array | 2:1 array | 2:1 array | 2:1 array |
| on NF 90-400 | | | 60% | 50% | 45% | 40% |
| per element | | | Recovery | Recovery | Recovery | Recovery |
| Max | 0.17 | | 0.17 | 0.13 | 0.12 | 0.10 |
| Recovery | | | | | | |
| Max | 29.9 | m³/d | (56.7) | (44.53) | (38.97) | (33.8) |
| Permeate | | | | | | |
| Max | 41.37 | bar | (55.9) | (45.98) | (42.2) | 39 |
| Pressure | | | | | | |
| Max Feed | 397.9 | m³/d | | | (414) | (44.6) |
| | | | | | (second | |
| | | | | | stage) | |

| | | | | | |
|---|---|---|---|---|---|
| | GOAL | | | | |
| System | 17 | 22 | 18 | 16 | 14.5 |
| Flux | | | | | |
| 1^{st} Stage | 11± | 30 | 24 | 22 | 19.38 |
| Flux | | | | | |
| 2^{nd} Stage | 6± | 5.4 | 5.1 | 5.0 | 4.34 |
| Flux | | | | | |

*Items in parentheses indicate design errors/warnings.

### Example 5

The same test run in Example 4 was run again, except with a single-stage system, in order to determine the design limitations of the NF system. Table 5 shows the results obtained from a NF single-stage system comprising a Dow NF 90-400 system with water having temperature of 18° C. From the results of Example 5, it was concluded that single-stage low recovery of approximately 42% will not result in design error and keeps upstream of skid the same as SWRO.

TABLE 5
NF Projection Run Results from single-stage system

| | | | NF Projection Run Results | | | |
|---|---|---|---|---|---|---|
| | | | Single | Single | Single | Single |
| Dow Limits | | | Stage | Stage | Stage | Stage |
| on NF 90-400 | | | 50% | 47% | 45% | 42% |
| per element | | | Recovery | Recovery | Recovery | Recovery |
| Max | 0.17 | | 0.17 | 0.15 | 0.14 | 0.13 |
| Recovery | | | | | | |
| Max | 29.9 | m³/d | (37.8) | (34.6) | (32.5) | 29.5 |
| Permeate | | | | | | |
| Max | 41.37 | bar | (44.6) | (42.2) | 40.7 | 38.6 |
| Pressure | | | | | | |
| Max Feed | 397.9 | m³/d | | | | |

| | | | | | |
|---|---|---|---|---|---|
| Goal | GOAL | | | | |
| System | 17 | (18.1) | 17 | 16.3 | 15.2 |
| Flux | | | | | |

*Items in parentheses indicate design errors/warnings.

### Example 6

A set of 3 samples of pretreated open intake seawater were fed separately to a single-stage NF system. The temperature of the water was 18° C. Table 6 shows the results for the set:

TABLE 6
Results for a set of 3 seawater samples run through a single-stage
NF system

| NF Membrane | Dow NF 90-400 | | Hydranautics ESNA-1-LFS | |
|---|---|---|---|---|
| Feed Pressure | 38.6 | bar | 33.4 | bar |
| Concentrate Pressure | 36.9 | bar | 31.9 | bar |
| Permeate TDS | 3077 | mg/L | 9815 | mg/L |
| Permeate SO₄ | 40 | mg/L | 130 | mg/L |

### Example 7

A second set of 3 samples of pretreated open intake seawater were fed separately to a single-stage NF system. The temperature of the water was 25° C. Table 7 shows the results for the set:

TABLE 7
Results for a set of 3 seawater samples run through a single-stage
NF system

| NF Membrane | Dow NF 90-400 | | Hydranautics ESNA-1-LFS | |
|---|---|---|---|---|
| Feed Pressure | 36.6 | bar | 30.6 | bar |
| Concentrate Pressure | 35.2 | bar | 29.1 | bar |
| Permeate TDS | 4472 | mg/L | 11824 | mg/L |
| Permeate SO₄ | 61 | mg/L | 158 | mg/L |

### Example 8

A third set of 3 samples of pretreated open intake seawater were fed separately to a single-stage NF system. The temperature of the water was 31° C. Table 8 shows the results for the set:

TABLE 8
Results for a set of 3 seawater samples run through a single-stage
NF system

| NF Membrane | Dow NF 90-400 | | Hydranautics ESNA-1-LFS | |
|---|---|---|---|---|
| Feed Pressure | 34.5 | bar | 27.8 | bar |
| Concentrate Pressure | 33.1 | bar | 26.2 | bar |
| Permeate TDS | 5612 | mg/L | 13777 | mg/L |
| Permeate SO₄ | 79.5 | mg/L | 187 | mg/L |

### Example 9

Three samples of pretreated open intake seawater were fed separately to a two-stage sulfate reducing nanofiltration (SRNF) system. Table 9 shows the results for the set:

TABLE 9
Results for a set of 3 seawater samples run through a two-stage NF system

| | Sample | | | | | |
|---|---|---|---|---|---|---|
| | 1 | | 2 | | 3 | |
| Temperature | 18° | C. | 25° | C. | 31° | C. |
| Feed Pressure | 18.5 | bar | 15.7 | bar | 13.8 | bar |
| Concentrate | 17.1 | bar | 14.4 | bar | 12.6 | bar |
| Pressure | | | | | | |
| Permeate TDS | 32550 | mg/L | 32700 | mg/L | 32800 | mg/L |
| Permeate SO₄ | 26 | mg/L | 31 | mg/L | 37 | mg/L |

From Examples 1-3 it was determined that the feed pressure for a SWRO system may range from about 47 to about 53 bar and that the concentrate pressure may range from about 45 to about 50 bar. From Examples 4-8 it was determined that the feed pressure for a standard NF system may range from about 27 to about 39 bar and that the concentrate pressure may range from about 26 to about 37 bar. From Example 9 it was determined that the feed pressure for a SRNF system may range from about 14 to about 19 bar and that the concentrate pressure may range from about 12 to about 17 bar.

Additionally, while the above embodiments were described as being application for offshore water treatment, one of ordinary skill in the art would appreciate that the treatment techniques may also be used in land-based operations, particularly when the feed water has a high salinity and/or high ionic content.

Furthermore, one skilled in the art in possession of this specification will appreciate that the system and method are also applicable to other water treatment environments. For example, by substituting one or more treatment blocks as appropriate, municipalities could use the system and method to produce potable or otherwise treated water.

Advantageously, one or more embodiments may provide one or more of the following. In offshore operations, the most common source of injection water is seawater, which has significant levels of contaminants that may be removed before the seawater can be used as an injection water. Depending on the type of formation being drilled, certain components of the seawater must be removed while others must remain in order to protect the formation from damage and to maximize the hydrocarbons produced from the formation. Using a combination of water treatment approaches may allow for water treatment processes which are able to effectively and cost efficiently prepare injection water that is specifically tailored for the formation being drilled and thereby allow for improved oil recovery. Also, the water treatment processes may be used to reduce costs associated with the preparation of injection water because the most expensive component, i.e., the high-pressure pump, can be operated at variable pressures using the energy recovered from the rejection stream and, therefore, used for more than one membrane type.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed:

1. A method for treating water comprising:
intaking water into at least one treatment block;
wherein the treatment block comprises:
a membrane pressure vessel comprising at least one membrane element,
wherein the treatment block is configured such that the intake water is fed through the at least one membrane element of the membrane pressure vessel,
feeding the intake water through the membrane pressure vessel at a custom pressure based on the at least one membrane element of the membrane pressure vessel, and
separating the intake water into at least an aqueous permeate stream and a concentrate reject stream; and
outputting the aqueous permeate stream and the concentrate reject stream.

2. The method of claim 1 further comprising:
arranging a plurality of membrane elements in series within the membrane pressure vessel,
wherein the plurality of membrane elements comprise different types of membrane elements.

3. The method of claim 1 further comprising:
arranging a plurality of treatment blocks in series; and
feeding the aqueous permeate stream output from a first treatment block of the plurality of treatment blocks into a next treatment block of the plurality of treatment blocks.

4. The method of claim 1 further comprising:
arranging a plurality of treatment blocks in parallel; and
feeding the intake water into the plurality of treatment blocks,
wherein each treatment block respectively outputs the aqueous permeate stream and the concentrate reject stream.

5. The method of claim 1, further comprising:
changing the at least one membrane element of the membrane pressure vessel to a different membrane element; and
feeding the intake water through the membrane pressure vessel at a different custom pressure based on the different membrane element of the membrane pressure vessel.

6. The method of claim 1, further comprising:
recovering energy from the concentrate reject stream.

7. The method of claim 6, wherein the energy recovered from the concentrate reject stream is used in the production of the custom pressure at which the intake water is fed through the membrane pressure vessel.

8. The method of claim 1, wherein at least sulfate ions have been removed from the aqueous permeate stream by the at least one membrane element of the membrane pressure vessel.

9. The method of claim 1, wherein, after being fed through the treatment block, the aqueous permeate stream has salinity in the range of about 2 mg/L to about 4000 mg/L.

10. The method of claim 1, further comprising:
prior to feeding the intake water through the membrane pressure vessel, filtering the intake water to remove any large contaminants; and
prior to feeding the intake water through the membrane pressure vessel, filtering the intake water to remove large molecules,
wherein the large contaminants comprise at least one of sand, rocks, plants, debris, and combinations thereof, and
wherein the large molecules comprise at least one of suspended solids, colloids, macromolecules, bacteria, oils, particulate matter, proteins, high molecular weight solutes, and combinations thereof.

11. A membrane-based water treatment system, comprising:
a water intake system that intakes water;
at least one treatment block, comprising:
a variable speed high-pressure pump; and
a membrane pressure vessel comprising at least one membrane element,
wherein the variable speed high-pressure pump feeds the intake water through the membrane pressure vessel at a custom pressure based on the membrane elements comprised in the membrane pressure vessel, and
wherein the membrane pressure vessel separates the intake water into at least an aqueous permeate stream and a concentrate reject stream; and
an output system that respectively outputs the aqueous permeate stream and the concentrate reject stream.

12. The system of claim 11, wherein the membrane pressure vessel comprises:
a plurality of membrane elements arranged in series,
wherein the plurality of membrane elements comprise different types of membrane elements.

13. The system of claim 12, wherein the at least one membrane element comprises at least one of a reverse osmosis element, a nanofiltration element, and combinations thereof.

14. The system of claim 11, further comprising:
a plurality of treatment blocks arranged in series,
wherein the aqueous permeate stream output from a first treatment block of the plurality of treatment blocks is fed into a next treatment block of the plurality of treatment blocks.

15. The system of claim 11, further comprising:
a plurality of treatment blocks arranged in parallel,
wherein the intake water is fed into the plurality of treatment blocks, and
wherein each treatment block respectively outputs the aqueous permeate stream and the concentrate reject stream.

16. The system of claim 11, wherein the at least one membrane element of the membrane pressure vessel is capable of being replaced by a different membrane element, and wherein the variable speed high-pressure pump is capable of feeding the intake water through the membrane pressure vessel at a different custom pressure based on the different membrane element.

17. The system of claim 11, further comprising:
an energy recovery system adapted to recover energy from the concentrate reject stream.

18. The system of claim 17, wherein the energy recovery system comprises:
a turbobooster coupled to the variable speed high-pressure pump,
wherein the energy recovered from the concentrate reject stream is used in the production of the custom pressure at which the intake water is fed through the membrane pressure vessel.

19. The system of claim 11, wherein the membrane-based water treatment system is installed on land; a self-propelled ship; a moored, towed, pushed or integrated barge; a rig; or seafloor-mounted vessel.

20. The system of claim 11, wherein the output system comprises:
a concentrate discharge system capable of discharging the concentrate reject stream,
wherein the concentrate discharge system comprises a plurality of discharge ports disposed on one or more variable-depth extension members.
